(19) United States
(12) Patent Application Publication
(10) Pub. No.: US 2024/0052108 A1
(43) Pub. Date: Feb. 15, 2024

(54) PRODUCTION OF ALKOXYSILOXANES

(71) Applicant: Evonik Operations GmbH, Essen (DE)

(72) Inventors: Wilfried KNOTT, Essen (DE); Horst DUDZIK, Essen (DE); Frauke HENNING, Essen (DE)

(73) Assignee: Evonik Operations GmbH, Essen (DE)

(21) Appl. No.: 18/447,527

(22) Filed: Aug. 10, 2023

(30) Foreign Application Priority Data
Aug. 12, 2022 (EP) 22190104.4

(51) Int. Cl. C08G 77/18

(52) U.S. Cl. CPC C08G 77/18

(57) ABSTRACT

A process for producing one or more alkoxysiloxanes by thermal reaction of at least one siloxane parent structure with at least one alkali metal alkoxide and at least one alcohol, where the process includes mixing, while heating, the at least one siloxane parent structure with the at least includes one alcohol and the at least one alkali metal alkoxide to form a reaction mixture, neutralizing the reaction mixture by addition of at least one Brønsted acid and optionally with addition of at least one solvent, and subsequently isolating the one or more alkoxysiloxanes by thermal separation of volatile compounds. Potentially occurring water is not removed from the reaction mixture and the reaction mixture does not include solvents which form an azeotrope with water and/or further dehydrating agents.

The invention is in the field of silicones. It relates in particular to a process for producing one or more alkoxysiloxanes by the reaction of at least one siloxane parent structure with at least one alkali metal alkoxide and at least one alcohol which is carried out without removal of any potentially occurring water from the reaction mixture. It further relates to alkoxysiloxanes obtainable by such a process and to the use of such alkoxysiloxanes.

Alkoxysiloxanes are siloxanes comprising one or more, preferably two, alkoxy groups. Linear α,ω-dialkoxysiloxanes are particularly preferred alkoxysiloxanes in the context of the present invention, with linear α,ω-dialkoxypolydimethylsiloxanes being very particularly preferred.

Methods for producing alkoxysiloxanes are known. In particular, various methods are reported which describe the substitution of silicon-bonded, reactive groups by alkoxy radicals. Without going into any great detail about these, in some cases very old, synthetic routes which proceed substantially via the substitution of chlorine and/or hydrogen (dehydrogenative route) we refer to W. Noll, Chemie und Technologie der Silicone, Verlag Chemie GmbH, Weinheim, (1960), pages 60-61, as a reference elucidating the preparative options, which discusses the conversion of groups that are reactive but bonded to the silanic silicon into alkoxysilanes.

By contrast, a considerably smaller number of works are concerned with routes to alkoxysiloxanes starting from non-functional siloxanes.

In U.S. Pat. No. 2,881,199 Bailey et al. claim the production of alkoxy-bearing silanes and also alkoxy-bearing di- and trisiloxanes by acid-catalyzed reaction of cyclic siloxanes with alcohols under reflux conditions and with continuous, azeotropic removal of the water formed during the reaction. As a consequence of the acidic reaction conditions the authors expect the very slow reactions (24 hours) to additionally result in an undesired etherification reaction of the employed alcohol.

Also under acid catalysis Zhurkina et al. (Zh. Obshch. Khim. 1989, 59, 1203-1204) react ethyl orthoformate esters with octamethylcyclotetrasiloxane under mild conditions (16-20° C.) to afford a diethoxyoctamethyltetrasiloxane-containing reaction mixture and isolate this siloxane by subsequent vacuum distillation. The extent to which the use of ethyl orthoformate esters as an exotic water scavenging reagent allows acceptable yields is not referenced, though it is indicated that ethyl formate does not react under these conditions.

Base-catalyzed siloxane rearrangements are also known.

Accordingly, the teaching of U.S. Pat. No. 3,477,988 is directed to the base-catalyzed rearrangement of siloxanes in the presence of organophosphorus compounds such as in particular hexamethylphosphoric triamide and even includes the utilization of relatively high molecular weight hydrolyzates, rubbers and elastomers. The need to employ aprotic polar solvents such as the carcinogenic hexamethylphosphoric triamide is a barrier to the use of the teaching in industry.

Chang et al. (J. Polym. Res. 2005, 12, 433-438) report the nucleophilic cleavage of crosslinked polysiloxanes to obtain cyclic siloxane monomers which comprised initially swelling a crosslinked, filled polydimethylsiloxane with 4 or 5 volumes of tetrahydrofuran, toluene or diethylamine at room temperature overnight and subsequently treating the thus-swollen samples with separately prepared, homogeneous solutions of potassium hydroxide in dimethylamine and dissolving them with stirring at room temperature. The authors observed complete dissolution of the silicone rubber constituents over periods of 0.4 to 4 hours. The yields of cyclic products determined after 25 hours of reaction time were in the range from 10% by weight to 77% by weight, wherein the yield of the dissolution experiment performed in diethylamine exceeded the yields determined for the experiments run in tetrahydrofuran, tetrahydrofuran/toluene and toluene.

In K'o Hsueh Tung Pao, 1959, 3, 92-93 Wang and Lin report the decomposition of polyorganosiloxanes by butanolysis, wherein sodium hydroxide is employed as a cleavage reagent and a butanol-water azeotrope is continuously discharged from the reaction system. The authors are unable to solve the dilemma of an alkali-induced polymerization proceeding in effective competition with the alkoxy functionalization which—since it is uncontrolled—produces both short-chain and long-chain cleavage products. In Zh. Obshch. Khim. 1959, 29, 1528-1534 (Russian Journal of General Chemistry 1959, 29, 1528-1534) Vornokov and Shabarova describe the production of organoalkoxysilanes by cleavage of organosiloxanes with alcohols under basic conditions, wherein alkali metal hydroxides, alkali metal alkoxides or the alkali metals themselves are employed.

The authors interpret the reaction of the organosiloxane with alcohol as an equilibrium reaction where it is important to remove water of reaction from the reaction system azeotropically or using an inert, water-insoluble solvent or else preferably by addition of tetralkoxysilanes as dehydrating agents. Neither the production of alkoxysilanes derivable from alcohols having boiling points below 90° C. nor the attainment of high yields of alkoxysilanes are possible without the use of dehydrating reagents.

By contrast, the publication does not provide a solution for the production of alkoxysiloxanes since, as is understood by those skilled in the art, especially any remaining high-boiling tetraalkoxysilanes (for example tetraethoxysilane b.p. 168° C.) and the condensation products resulting therefrom would entail considerable separation and purification effort.

Petrus et al. report the solvothermal alcoholysis of crosslinked silicone rubber wastes (Macromolecules 2021, 54, 2449-2465) and describe inter alia the dissolution of shredded silicone rubber in a high-pressure reactor using n-octanol in the temperature range between 180° C. and 240° C. and over reaction times between 16 and 18 hours.

The conversions of the reaction are reported in the range from 22% to 80% and analysis demonstrates that alkoxyoligosiloxanes were formed. To interpret the initially surprising finding that a crosslinked siloxane is apparently amenable to uncatalyzed alcoholysis, Petrus et al. assume that the high digestion temperatures above 200° C. in conjunction with moisture liberate acid traces from the peroxidically crosslinked silicone rubber, which then catalyze the cleavage of the Si—O—Si bonds.

In order to try to perform said alcoholysis reaction more effectively, i.e. over shorter reaction times, at reduced temperatures and also at lower catalyst loading, Petrus et al. (ibid.) employ alkali metal aryl oxides aided by the methylsalicylato ligand, and magnesium and zinc aryl oxides and mixed metal aryl oxides with methylsalicylato ligands as catalysts. The best complex in this investigation was found to be the magnesium-sodium-potassium aryl oxide [Mg₂M′₂ (MesalO)₆(THF)₄], where M′=Na, K and MesalO is the methylsalicylato ligand, with which production of dioctanoxydimethylsilane and 1,3-dioctanoxy-1,1,3,3-tetramethyldisiloxane in yields of 79%/17% over 2 hours at a reaction temperature of 220° C. can be achieved.

Furthermore, Okamoto et al. in Appl. Catalysis A: General 261 (2004), 239-245 describe the depolymerization of polysiloxanes and of SiO₂-filled silicone rubber with dimethyl carbonate and methanol to afford methyl trimethylsilane and dimethoxy dimethylsilane and liberate carbon dioxide, wherein not only alkali metal halides but also potassium hydroxide and sodium methoxide are used as catalysts. Performing the process requires an autoclave since the depolymerization is performed at 180° C. over a period of 15 hours. When using solely methanol or dimethyl carbonate only 2 to 3 percent depolymerization achieved. The authors conclude from their experiments that both dimethyl carbonate and methanol must be added to depolymerize polysiloxanes. The need for both a pressure-resistant apparatus and a complex digestion system, as well as lengthy reaction times at high temperature, make this route unattractive for an industrial reaction.

In light of all of these efforts, the technical problem to be solved is defined as that of finding a practical, timesaving and very simple synthetic route to alkoxysiloxanes starting from siloxane parent structures which can eschew complex chemical systems such as in particular multi-component solvent mixtures and exotic catalysts and ideally also specialized apparatuses.

Cited as a reference in relation to the M, D, T, Q nomenclature used in the context of this document to describe the structural units of organopolysiloxanes is W. Noll, Chemie und Technologie der Silicone [Chemistry and Technology of the Silicones], Verlag Chemie GmbH, Weinheim (1960), page 2 ff.

In the context of the invention the term “siloxane parent structures” is in particular to be understood as meaning siloxanes constructed predominantly from D units, preferably for example siloxane cycles such as hexamethylcyclotrisiloxane (D₃), octamethylcyclotetrasiloxane (D₄), decamethylcyclopentasiloxane (D₅), dodecamethylcyclohexasiloxane (D₆) and/or any desired mixtures thereof. In the context of the present invention the term “siloxane parent structures” is likewise to be understood as encompassing in particular also mixtures of cyclic-branched siloxanes of the D/T type, preferably produced as described in EP 3321304 A1, EP 3401353 A1 or EP 3467006 A1, which preferably in a mixture with siloxane cycles, for example octamethylcyclotetrasiloxane (D₄), decamethylcyclopentasiloxane (D₅) and/or dodecamethylcyclohexasiloxane (D₆), generate branched alkoxy-bearing siloxanes after processing according to the invention.

Cyclic branched siloxanes of the D/T type are cyclic siloxanes constructed from D- and T-units. Mixtures of cyclic branched siloxanes of the D/T type are accordingly mixtures of cyclic siloxanes constructed from D- and T-units. Mixtures of cyclic branched siloxanes of the D/T type are described in the patent literature.

Thus, for example, EP 3401353 A1 describes mixtures of cyclic branched siloxanes comprising D and T units and a process for the production thereof, comprising (a) an acid-catalysed equilibration of trialkoxysilanes with siloxane cycles and/or α,ω-dihydroxypolydimethylsiloxane in the presence of at least one acidic catalyst and then (b) a hydrolysis and condensation reaction initiated by water addition, and addition of a silicon-containing solvent, followed by (c) distillative removal of the liberated alcohol, of water present in the system and of silicon-containing solvent and neutralization or removal of the acidic catalyst and optionally removal of any salts that may have formed, wherein the silicon-containing solvent preferably comprises the isomeric siloxane cycles octamethylcyclotetrasiloxane (D4), decamethylcyclotetrasiloxane (D5) and/or mixtures thereof, and mass ratios of silicon-containing solvent to the siloxane comprising D and T units of 1:1 to 5:1 are advantageously employed.

EP 3 321 304 A1 describes mixtures of cyclic branched siloxanes comprising D and T units and a process for the production thereof, wherein a trialkoxysilane is reacted with siloxane cycles and/or α,ω-dihydroxypolydimethylsiloxane in a solvent with addition of water and in the presence of at least one acidic catalyst.

EP 3 467 006 A1 describes mixtures of cyclic branched siloxanes comprising D and T units and a process for the production thereof comprising
(a) an acid-catalysed equilibration of trialkoxysilanes with siloxane cycles and/or aw-dihydroxypolydimethylsiloxane in the presence of at least one acidic catalyst and then
(b) a hydrolysis and condensation reaction initiated by water addition followed by the addition of a silicon-containing solvent,
(c) with subsequent distillative removal of the liberated alcohol and proportions of the water present in the system,
(d) with subsequent addition of toluene and continuous discharging of residual water remaining in the system,
(e) followed by neutralization or removal of the acidic catalyst and optionally removal of any salts that may have formed,
(f) with subsequent distillative removal of toluene remaining in the system, wherein the silicon-containing solvent preferably comprises the isomeric siloxane cycles octamethylcyclotetrasiloxane (D₄), decamethylcyclotetrasiloxane (D₅) and/or mixtures thereof, and mass ratios of silicon-containing solvent to the siloxane comprising D and T units of 1:1 to 5:1 are advantageously employed.

Polydimethylsiloxanediols and silicone oils (preferably silicone oils comprising at least 100 D units), may also likewise be regarded as preferably employable siloxane parent structures, wherein the use of silicone oils is likewise preferred but less preferred since—depending on their respective average chain length—they may introduce a proportion of trimethylsilyl groups into the reaction system.

It has now been found that, surprisingly, the abovementioned object is solved by the subject matter of the invention. The subject matter of the invention is a process for producing one or more alkoxysiloxanes by thermal reaction of at least one siloxane parent structure with at least one alkali metal alkoxide and at least one alcohol, wherein the process comprises
a) a first step of reacting at least one siloxane parent structure by mixing with at least one alcohol and at least one alkali metal alkoxide with heating but without removing any potentially occurring water from the reaction mixture, in particular without the use of solvents which form an azeotrope with water and/or without the use of further dehydrating agents, and
b) a second step of neutralizing the reaction mixture resulting from the first step a) by addition of at least one Brønsted acid and optionally with addition of at least one solvent, and preferably separating, by filtration, solid constituents and
c) subsequently isolating the alkoxysiloxane(s) by thermal separation of volatile compounds,
   wherein the at least one siloxane parent structure is selected from the group consisting of hexamethylcyclotrisiloxane (D₃), octamethylcyclotetrasiloxane (D₄), decamethylcyclopentasiloxane (D₅), dodecamethylcyclohexasiloxane (D₆), mixtures of cyclic branched siloxanes of the D/T type, silicone oils (preferably silicone oils comprising at least 100 D units), polydimethylsiloxanediols and α,ω-divinylsiloxanes. One or more of the abovementioned siloxane parent structures may be used.

Surprisingly, and thus also in a complete departure from the teaching of Vornokov (see above), which refers to alkoxysilanes, the process according to the invention for producing alkoxysiloxanes eschews any water-incompatible solvents as azeotrope-formers, let alone dehydrating substances such as for example tetraalkoxysilanes. According to the invention the reaction of at least one siloxane parent structure with at least one alcohol and at least one alkali metal alkoxide in the first step (a) is carried out without removal of any occurring water from the reaction mixture.

According to the invention at least one siloxane parent structure is reacted with at least one alcohol and at least one alkali metal alkoxide in a first step with thorough mixing and with heating. In a preferred embodiment of the invention the reaction may be performed at standard pressure, i.e. at an external air pressure of 1013.25 hPa acting on the apparatus. Advantageously for the achievable space-time yield of alkoxysiloxanes, i.e. the proportion of introduced alkoxy functionality based on the entirety of all Si units per unit time, and thus also particularly preferably, in a preferred embodiment of the invention the first step in particular may be performed using alcohols having boiling points below 100° C. under superatmospheric pressure conditions in a pressure-resistant reactor. The recorded pressure increase is autogeneous in nature and is attributable to the vapor pressure of the system components involved therein. If desired the reactor may additionally also be performed under an optional inert gas cushion.

In the context of the present invention “alkali metal alkoxide” is preferably to be understood as meaning compounds of general formula:

[M⁺][OR⁻],

wherein
M is selected from the group of alkali metals Li, Na or K, preferably Na or K, and wherein
R represents a linear, branched or cyclic alkyl radical, preferably having 1 to 10 carbon atoms, particularly preferably having 1 to 6 carbon atoms, very particularly preferably having 1 or 2 carbon atoms; in a preferred embodiment of the invention the at least one alkali metal alkoxide is selected from the abovementioned compounds. The use of the potassium ethoxide, sodium ethoxide, potassium methoxide and/or sodium methoxide is most preferred. One or more alkali metal alkoxides may be employed.

The known processes for producing alkoxides include chloralkali electrolysis by the amalgam process where sodium amalgam is reacted with alcohol [cf. for example Chemical and Engineering News 22, 1903-06 (1944)].

A further known method is the production of alkoxides from an alkali metal and an alcohol or from an alkali metal hydroxide and an alcohol. Alkoxide production from an alkali metal and a tertiary alcohol is known for example from DE-23 33 634 (Dynamit Nobel) or DE-26 12 642 (Degussa). Production of an alkoxide from an alkali metal hydroxide and a tertiary alcohol is likewise known. The first process variant requires the use of costly alkali metal and the second variant proceeding from alkali metal hydroxide requires that the water formed during the reaction be removed by distillation, thus necessitating correspondingly high thermal outlay.

According to the teaching of DE-A-33 46 131 alkali metal alkoxides are produced from salts by electrolysis, employing an electrolysis cell where a cation exchange membrane separates the electrode spaces. DE-42 33 191.9-43 describes a process which allows production of an alkali metal alkoxide from a salt by electrodialysis.

Also described individually are processes for producing speciality alkoxides, for example the alkoxides of higher and/or polyhydric alcohols.

Alkoxides of higher and/or polyhydric alcohols are known to be producible in principle by transalcoholization, i.e. by substitution of the alkoxide radical of lower alkoxides ROM by reaction with higher alcohols R′OH (wherein R and R′ are alkyl radicals of different carbon chain length and M represents a metal cation) in a liquid reaction mixture at suitable temperature and pressure conditions. In the laboratory jargon this reaction is also referred to as “recooking”. The position of the equilibrium ROM+R′OH⇔ROH+R′OM depends on the acidity of the two alcohols which decreases according to the sequence methanol>primary>secondary>tertiary alcohols [R. T. McIver and J. A. Scott, J. American Chem. Soc. 96 (1973) 2706]. Accordingly, it is said that the production of the alkoxides of secondary alcohols in this way is possible only in exceptional cases and the production of the alkoxides of tertiary alcohols by transalcoholization is entirely unsuccessful [“Methoden der Organischen Chemie” (1963) Vol. 6/2, p. 13]. However, DE-1 254 612 and DE-27 26 491 (both Dynamit Nobel) disclose the production of alkoxides by recooking for higher alcohols too. GB-1 143 897 (Metallgesellschaft) describes the reaction of a monovalent alkali metal alkoxide with a C₂ to C₁₈ alcohol or phenol containing up to six hydroxyl groups, wherein an excess of monohdyric alcohol and/or a hydrocarbon is employed as solvent.

However, the recooking always leads to formation of the low-boiling alcohol ROH (for example methanol) which, for isolation of the desired alkoxide—optionally in addition to the unconverted higher alcohol R′OH—requires removal from the reaction product mixture in some cases with considerable thermal outlay.

Apart from these thermal equilibrium shifts, EP0776995 (B1) also teaches a process for producing alkoxides under the influence of an electric field, wherein an alcohol is converted into the desired alkoxide by supplying metal ions and the metal ions themselves derive from the electrochemical decomposition of another alkoxide in the electric field. The alkoxide formation and decomposition are carried out in chambers spatially separated by ion exchange membranes.

The alkali metal alkoxides obtained in particular by the described routes are obtainable commercially both as solids and in the form of their alcoholic solutions.

Preferably, the thermal reaction of the at least one siloxane parent structure in the first step (a) may preferably be performed at temperatures between 50° C. and 200° C., preferably between 60° C. and 150° C., in particular between 64° C. and 120° C., and in a period of preferably 1 to 12 hours, preferably in a period of 2 to 8 hours, in each case preferably solventlessly.

It is preferable when the at least one alkali metal alkoxide is employed in total amounts of 1% to 10% by mass, preferably of 2% to 7% by mass, particularly preferably of 3% to 6% by mass, based on the total amount of the at least one siloxane parent structure. This corresponds to a preferred embodiment of the invention.

The at least one alcohol is preferably selected from the group of C₁ to C₁₀ alkanols. Particular preference is given to methanol, ethanol, 1-propanol, isopropanol, 1-butanol, 2-butanol, isobutanol, pentanols, hexanols, heptanols, octanols, nonanols and/or decanols, in each case also including the isomers thereof, particularly preferably methanol and/or ethanol. One or more alcohols may be employed.

It is preferable when the at least one alcohol is employed in total amounts of 10% to 200% by mass, preferably of 20% to 100% by mass, particularly preferably in amounts of 30% to 80% by mass, based on the total mass of the at least one siloxane parent structure.

In the industrial application of the process according to the invention, especially in explosion-protected operating parts, the handling and addition of solid alkali metal alkoxide into the reactor can entail a technical challenge. Accordingly, in a further particularly preferred embodiment of the invention the at least one alkali metal alkoxide may be employed in the form of an alcoholic solution, and then preferably dissolved in the anhydrous alcohol used to prepare the alkoxide.

According to the invention the reaction mixture resulting from the first step (a) is neutralized by addition of at least one Brønsted acid and optionally with addition of at least one solvent, in a second step (b). One or more Brønsted acids may thus be employed. Preferably anhydrous mineral acids (such as preferably anhydrous sulfuric acid and/or anhydrous perchloric acid) and/or particularly preferably anhydrous organic acids (such as preferably anhydrous acetic acid) may be used for neutralization.

When using preferably anhydrous mineral acids the addition amount thereof is preferably chosen such that stoichiometric equivalence based on the altogether employed at least one alkali metal alkoxide is achieved. When using the markedly weaker, anhydrous organic acids (for example anhydrous acetic acid) it is preferable to choose a marked stoichiometric excess of acid based on the altogether employed at least one alkali metal alkoxide. This is preferably up to a 50% excess.

The usage amount of the altogether employed at least one Brønsted acid is thus preferably chosen such that it is in the range from stoichiometric equivalence to a 50% stoichiometric excess, in each case based on the altogether employed at least one alkoxide.

If the amount of salt expected from the neutralization step according to the invention stands in the way of easy filtration it is thus preferable to provide for the use of at least one solvent. One or more solvents may optionally be employed. The optional one or more solvents which are preferably suitable are those solvents which are themselves chemically inert with regard to the reaction system and which promote dilution/dispersion of the constituents of the neutralization step. It is preferable when the at least one solvent is selected from the group consisting of alkanes and alkylaromatics. The use of alkylaromatics, such as preferably toluene and/or also isomeric xylenes and mixtures thereof, is particularly preferred.

This affords the corresponding alkoxysiloxanes in simple and selective fashion, in particular those which in the ²⁹Si-NMR spectrum, apart from the signal positions characteristic of —OSi(CH₃)₂OR groups, do not have OSi(CH₃)₂OH signals typical of hydroxypolydimethylsiloxanes (Example 1 and 2).

The invention accordingly further provides alkoxysiloxanes produced by the process according to the invention.

The alkoxysiloxanes obtained according to the invention may be used as starting materials for polymerization-active masses and then preferably by addition of suitable crosslinking catalysts as sealants and/or adhesives, optionally also blended with further crosslinking silanes and/or siloxanes, optionally filled with fillers and/or pigments and/or unfilled.

The invention thus further provides for the use of the alkoxysiloxanes obtained according to the invention as polymerization-active masses. The use of the alkoxysiloxanes obtained according to the invention as adhesives and/or sealants is preferred.

The alkoxysiloxanes obtained according to the invention are furthermore also suitable for example as starting materials for producing SiOC-bonded polyether siloxanes by transesterification with polyetherols in the presence of zinc acetylacetonate as catalyst, such as disclosed in European patent application EP3438158 (B1).

The invention accordingly further provides for the use of the alkoxysiloxanes obtained according to the invention for producing SiOC-bonded polyethersiloxanes by transesterification of the alkoxysiloxanes with polyetherols in the presence of zinc acetylacetonate as catalyst.

If for example particular number-average siloxane chain lengths are desired prior to the further processing described here, the alkoxysiloxanes obtained according to the invention may optionally also be subjected to a downstream, preferably acid-catalyzed, equilibration to establish the target chain lengths.

It is likewise possible for example to convert the alkoxysiloxanes obtained according to the invention into the corresponding acetoxy-bearing siloxanes for example through reaction in a reaction medium comprising acetic anhydride, perfluoroalkanesulfonic acid (in particular trifluoromethanesulfonic acid) and preferably acetic acid with continuous discharging of the respective acetic ester, as described in patent application EP 3663346 A1, and to likewise use these as reactive intermediates, such as for example for producing SiOC-bonded polyether siloxanes or else as starting materials for polymerization-active masses.

### EXAMPLES

The examples which follow serve merely to elucidate the present invention to those skilled in the art and do not constitute any limitation of the claimed subject matter whatsoever. ²⁹Si-NMR spectroscopy was used for reaction monitoring in all examples.

In the context of the present invention the ²⁹Si-NMR samples are analysed at a measurement frequency of 79.49 MHz in a Bruker Avance III spectrometer equipped with a 287430 sample head with gap width of 10 mm, dissolved at 22° C. in CDCl₃ and against a tetramethylsilane (TMS) external standard [δ(²⁹Si)=0.0 ppm].

Unless otherwise stated all percentages are to be understood as meaning weight percentages.

### Example 1 (Inventive)

100 g of D₅, 12.5 g of methanol and 5 g of sodium methoxide are weighed into a 300 ml pressure reactor from Roth fitted with a magnetic stirrer, a manometer and a heating mantle with an integrated thermocouple. With stirring of the reaction mass the sealed pressure reactor is then rapidly heated to 120° C. for 4 hours.

The reactor is allowed to cool and decompress and the free-flowing contents thereof are transferred into a glass beaker with a magnetic stirrer bar. The intermediate resulting from the reaction is stirred at 22° C. and admixed with 8.3 g of anhydrous acetic acid (50% stoichiometric excess). After 30 minutes the solid constituents are separated via a pleated filter. The isolated filtercake consists of a finely divided precipitate.

The obtained filtrate is freed of volatile constituents at a bottoms temperature of 70° C. and an applied auxiliary vacuum of <5 mbar on a rotary evaporator, wherein a slight clouding of the bottoms by post-precipitation is observed. Refiltration via a pleated filter affords a colourless clear liquid whose accompanying ²⁹Si-NMR spectrum verifies that a linear α,ω-dimethoxypolydimethylsiloxane of average chain length N=25.6 has been formed. Apart from the signal positions characteristic of —OSi(CH₃)₂OCH₃ no —OSi(CH₃)₂OH signals are observed whatsoever.

### Example 2 (Inventive)

85 g of D₅ together with 15 g of ethanol are initially charged with stirring into a 500 ml four-necked round-bottomed flask equipped with KPG glass blade stirrer and fitted with a reflux cooler and admixed with 5 g of pulverulent potassium methoxide (KOC₂H₅, manufacturer Evonik Industries).

The mixture is allowed to react at 80° C. over a period of 6 hours with further stirring. The batch is subsequently cooled to 60° C., admixed with 5.3 g of anhydrous acetic acid (50% excess) and stirred for 30 minutes at this temperature. The solids fractions are separated using a filter press (K 300 filter disc).

A sample of the thus obtained, clear and colourless filtrate is analyzed by ²⁹Si-NMR spectroscopy. The characteristic signal positions of the accompanying ²⁹Si-NMR spectrum demonstrate that a linear α,ω-dimethoxypolydimethylsiloxane having an average chain length of about 22 was formed. Apart from the signal positions characteristic of —OSi(CH₃)₂OC₂H₅ no —OSi(CH₃)₂OH signals are observed whatsoever.

1. A process for producing one or more alkoxysiloxanes by thermal reaction of at least one siloxane parent structure with at least one alkali metal alkoxide and at least one alcohol, wherein the process comprises:
mixing, while heating, the at least one siloxane parent structure with the at least one alcohol and the at least one alkali metal alkoxide to form a reaction mixture,
wherein potentially occurring water is not removed from the reaction mixture,
wherein the reaction mixture does not comprise solvents which form an azeotrope with water and/or further dehydrating agents;
neutralizing the reaction mixture by addition of at least one Brønsted acid and optionally with addition of at least one solvent; and
subsequently isolating the one or more alkoxysiloxanes by thermal separation of volatile compounds,
wherein the at least one siloxane parent structure is selected from the group consisting of hexamethylcyclotrisiloxane (D₃) octamethylcyclotetrasiloxane (D₄, decamethyl-cyclopentasiloxane (D₅), dodecamethylcyclohexasiloxane (D₆), mixtures of cyclic branched siloxanes of a D/T type, silicone oils, polydimethylsiloxanediols and α,ω-divinylsiloxanes.

2. The process of claim 1, wherein the at least one alkali metal alkoxide conforms to the general formula
[M⁺][OR⁻],
wherein
M is selected from the group of alkali metals Li, Na, K, Rb or Cs, and
R represents a linear, branched or cyclic alkyl radical.

3. The process of claim 1, wherein the at least one alcohol is selected from linear, branched and cyclic alkanols having 1 to 18 carbon atoms, and combinations thereof.

4. The process of claim 1, wherein during the mixing, the heating is at temperatures between 50° C. and 200° C., and the mixing is for 1 to 12 hours.

5. The process of claim 1, wherein the at least one alkali metal alkoxide is employed in a total amount of 1 to 10 mol %, based on the total amount of the at least one siloxane parent structure.

6. The process of claim 1, wherein the at least one alcohol is employed in a total amount of 10% to 200% by mass, based on the total amount of the at least one siloxane parent structure.

7. The process of claim 1, wherein the at least one Brønsted acid is an anhydrous mineral acid and/or an anhydrous organic acid.

8. The process of claim 1, wherein the at least one solvent is selected from the group consisting of alkanes and alkylaromatics.

9. The process of claim 1, wherein the one or more alkoxysiloxanes is α,ω-dimethoxypolydimethylsiloxane or α,ω-diethoxypolydimethylsiloxane.

10. Alkoxysiloxanes produced by the process of claim 1.

11. A polymerization-active mass, comprising the alkoxysiloxanes of claim 10.

12. A process for producing SiOC-bonded polyether siloxanes, comprising:
transesterifying the alkoxysiloxanes of claim 10 with polyetherols in a presence of a zinc acetylacetonate catalyst.

13. The process of claim 1, further comprising:
separating, by filtration, solid constituents following the neutralizing.

14. The process of claim 2, wherein the at least one alkali metal alkoxide is selected from potassium methoxide, potassium ethoxide, sodium methoxide and sodium ethoxide.

15. The process of claim 1, wherein the at least one Brønsted acid is selected from anhydrous sulfuric acid, anhydrous perchloric acid and anhydrous acetic acid.
